(19) United States
(12) Patent Application Publication
(10) Pub. No.: US 2023/0174111 A1
(43) Pub. Date: Jun. 8, 2023

(54) SYSTEM AND METHOD FOR INDUCING VEHICLE TO YIELD THE RIGHT OF WAY

(71) Applicants: HYUNDAI MOTOR COMPANY, Seoul (KR); KIA CORPORATION, Seoul (KR)

(72) Inventor: Myung Ki Yeom, Incheon (KR)

(73) Assignees: HYUNDAI MOTOR COMPANY, Seoul (KR); KIA CORPORATION, Seoul (KR)

(21) Appl. No.: 17/974,840

(22) Filed: Oct. 27, 2022

(30) Foreign Application Priority Data
Dec. 6, 2021 (KR) 10-2021-0172515

(51) Int. Cl. B60W 60/00; B60W 50/14; G08G 1/09; G08G 1/01

(52) U.S. Cl. CPC B60W 60/0027; B60W 50/14; G08G 1/091; G08G 1/0145; B60W 2554/402; B60W 2556/45; B60W 2720/10; B60W 2720/24

(57) ABSTRACT

A system and method for inducing vehicles to yield right of way determines whether a common vehicle is an emergency vehicle through a cloud, which transmits and receives requests and response signals between vehicles, when the common vehicle transmits a request signal showing that the common vehicle is an emergency vehicle, and informs surrounding vehicles that there is an emergency vehicle in a driving path and simultaneously provides a yielding driving guide signal, which includes a driving direction for yielding driving, a lane change direction of the emergency vehicle, whether to accelerate and decelerate, etc., to the surrounding vehicles so that yielding driving may be easily performed for specific vehicles with an emergency patient other than emergency vehicles such as an ambulance and a fire truck.

### CROSS REFERENCE TO RELATED APPLICATION

The present application claims priority to Korean Patent Application No. 10-2021-0172515, filed Dec. 6, 2021, the entire contents of which is incorporated herein for all purposes by this reference.

### BACKGROUND OF THE PRESENT DISCLOSURE

### Field of the Present Disclosure

The present disclosure relates to a system and method for inducing vehicles to yield right of way, and more particularly, to a system and method for inducing vehicles to yield the right of way, the system and method being able to induce vehicles to yield the right of way in accordance with a yielding request signal from a vehicle in an emergency.

### Description of Related Art

In general, yielding driving that adjusts the speed of a subject vehicle and moves the subject vehicle to a side so that emergency vehicles, such as an ambulance and a fire truck, can pass by after hearing a siren of the emergency vehicles and recognizing the emergency vehicles around the subject vehicle while driving is performed.

However, it is substantially difficult to definitely know the location of an emergency vehicle around a subject vehicle even though a siren of the emergency vehicle is heard, so it is difficult to rapidly yield to the emergency vehicle.

Furthermore, it is possible to easily recognize emergency vehicles such as an ambulance and a fire truck from only the external shape other than a siren, so yielding driving may be performed. However, because common vehicles with an emergency patient are not recognized as emergency vehicles, yielding driving is not performed, so that the condition of the emergency patient in common vehicles may become worse or an accident may occur due to haste of a driver while driving.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system and method for inducing vehicles to yield right of way, the system and method facilitating smooth yielding driving for emergency vehicles by informing surrounding vehicles that a specific vehicle is an emergency vehicle and providing surrounding vehicles with guide signal such as a driving direction, a lane change direction of the emergency vehicle, whether to accelerate or decelerate for yielding driving, using a cloud, etc. which is connected between vehicles and transmits and receives requests and response signals between vehicles.

To achieve the objectives, an exemplary embodiment of the present disclosure provides a system for inducing vehicles to yield right of way, the system including: a communication device mounted in each of a fleet of vehicles; a cloud configured to receive an emergency state signal from the communication device of a specific vehicle of the fleet of vehicles, and thereby to determine an emergency state, and then to transmit a guide signal requesting surrounding vehicles to yield the right of way to the specific vehicle in the emergency state; and an autonomous driving controller configured, based on the guide signal, to control the surrounding vehicles at a speed and in a direction so that a driving path of the specific vehicle in the emergency state may be secured.

The cloud is configured to conclude that the specific vehicle is in the emergency state when receiving a signal proving the emergency state from an emergency center, or to determine that the specific vehicle is in the emergency state when receiving an image showing that there is an emergency patient aboard the specific vehicle.

The cloud may be configured to transmit a yielding driving guide signal, which includes location information of the specific vehicle, a driving information of the specific vehicle, a lane change direction of the specific vehicle, a forward safety direction and a safety road width of the specific vehicle, a direction and a movement width for yielding driving of a surrounding vehicle, and whether to accelerate or decelerate the surrounding vehicle, to an autonomous driving controller of the surrounding vehicle.

The autonomous driving controller may be configured to determine an available road width for the surrounding vehicle based on the forward safety direction and the safety road width of the specific vehicle, and to determine a yielding driving width for one surrounding vehicle based on the determined available road width for the surrounding vehicle.

The autonomous driving controller may be configured to control the surrounding vehicle at a speed and in a direction for securing a driving path of the predetermined direction when the yielding driving width for one surrounding vehicle is greater than a sum of a width of the surrounding vehicle and a safety width.

The system may further include a display mounted in a vehicle and configured to display information of the yielding driving guide signal.

To achieve the objectives, an exemplary embodiment of the present disclosure provides a method for inducing vehicles to yield right of way, the method including: transmitting an emergency request signal to a cloud through a communication system of a specific vehicle; determining whether the specific vehicle is an emergency vehicle by the cloud; transmitting a yielding driving guide signal to a surrounding vehicle of the specific vehicle by the cloud when the specific vehicle is an emergency vehicle; and controlling the surrounding vehicle at a speed and in a direction for securing a driving path of the specific vehicle by an autonomous driving controller of the surrounding vehicle based on the yielding driving guide signal.

In the determining of whether the specific vehicle is an emergency vehicle, the cloud may determine that the specific vehicle is an emergency vehicle when receiving a signal, which proves that the specific vehicle is an emergency vehicle, from an emergency center, or the cloud may determine that the specific vehicle is an emergency vehicle when receiving an image signal showing that there is an emergency patient in the specific vehicle.

When transmitting a yielding driving guide signal to a surrounding vehicle, the cloud may transmit a yielding driving guide signal, which includes location information of the specific vehicle, a driving information of the specific vehicle, a lane change direction of the specific vehicle, a forward safety direction and a safety road width of the specific vehicle, a direction and a movement width for yielding driving of a surrounding vehicle, and whether to accelerate or decelerate the surrounding vehicle, to an autonomous driving controller of the surrounding vehicle.

The autonomous driving controller may further perform: determining an available road width for the surrounding vehicle based on the forward safety direction and the safety road width of the specific vehicle; and determining a yielding driving width for one surrounding vehicle based on the determined available road width for the surrounding vehicle.

The autonomous driving controller may be configured to control the surrounding vehicle at a speed and in a direction for securing a driving path of the specific direction when the yielding driving width for one surrounding vehicle is greater than a sum of a width of the surrounding vehicle and a safety width.

The method may further include displaying information of the yielding driving guide signal on a display mounted in a vehicle.

The present disclosure provides the following effects through the objectives described above.

First, when a specific vehicle transmits a request signal showing that the specific vehicle is an emergency vehicle to a cloud, the cloud, which transmits and receives requests and response signals between vehicles, determines whether the specific vehicle is an emergency vehicle, and then informs surrounding vehicles that there is an emergency vehicle in the driving path. Accordingly, yielding driving may be easily performed even for specific vehicles (common vehicles) with an emergency patient other than emergency vehicles such as an ambulance and a fire truck, and accordingly, it is possible to rapidly carry an emergency patient and take following measures.

Second, because the cloud provides a yielding driving guide signal, which includes a driving direction for yielding driving, a lane change direction of an emergency vehicle, whether to accelerate and decelerate, etc., yielding driving may be rapidly and smoothly performed for the emergency vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

The above and other objectives, features and other advantages of the present disclosure

FIG. 1 is a diagram showing the configuration of a system and method for inducing vehicles to yield right of way according to an exemplary embodiment of the present disclosure;

FIG. 2 and FIG. 3 are flowcharts showing the system and method for inducing vehicles to yield right of way according to an exemplary embodiment of the present disclosure;

FIG. 4, FIG. 5, and FIG. 6 are schematic diagrams showing an example in which yielding driving is performed when driving straight in a same lane as an emergency vehicle based on the system and method for inducing vehicles to yield right of way according to an exemplary embodiment of the present disclosure;

FIG. 7 is a schematic diagram showing an example in which yielding driving is performed when driving straight in lanes different from an emergency vehicle based on the system and method for inducing vehicles to yield right of way according to an exemplary embodiment of the present disclosure;

FIG. 8 and FIG. 9 are schematic diagrams showing an example in which yielding driving is performed when an emergency vehicle intends to turn based on the system and method for inducing vehicles to yield right of way according to an exemplary embodiment of the present disclosure; and

FIG. 10 is a schematic diagram showing an example in which yielding driving is performed when an emergency vehicle change the lane based on the system and method for inducing vehicles to yield right of way according to an exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

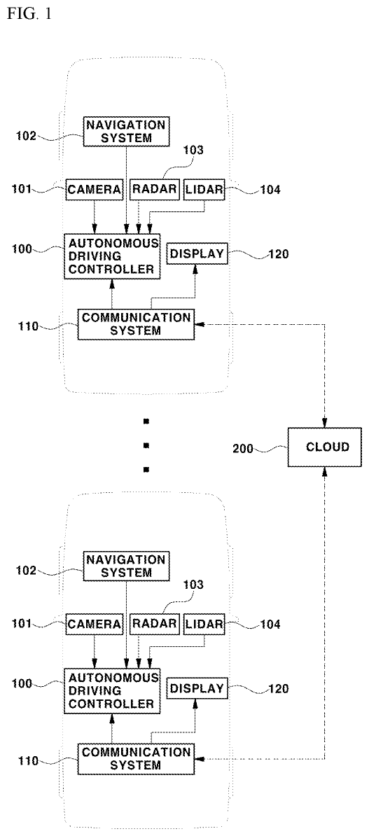

FIG. 1 is a diagram showing the configuration of a system and method for inducing vehicles to yield right of way according to an exemplary embodiment of the present disclosure.

Vehicles for yielding driving (particularly, autonomous vehicles) according to an exemplary embodiment of the present disclosure are provided with a communication system 110 connected to the internet so that communication is possible and are also provided with an autonomous driving controller 100 for generally controlling autonomous driving of an autonomous vehicles.

The autonomous driving controller 100, as well-known in the art, may be configured to generally control driving including the driving direction, acceleration, deceleration, etc. of a vehicle based on information provided from a camera 101, a navigation system 102, a Radio Detection and Ranging (RADAR) 103, and a Light Imaging Detection and Ranging (LIDAR) 104, etc. mounted in a vehicle.

For reference the radar 103 is a sensor that finds out information related to objects by emitting a radio frequency signal to a target and analyzing a reflective reception wave and the LiDAR 104 is a sensor that locates an object by measuring the time that a laser pulse takes to hit against a target and then return.

The autonomous driving controller 100 mounted in vehicles, as described above, is connected to a cloud 200 through the communication system 110 so that communication is possible, and the cloud 200 may be a central computer of a control center connected to the communication system 110 of each vehicle through the internet.

Instead of the cloud 200 which is connected so that communication is possible between vehicles and that transmits and receives requests and response signals between vehicles, Vehicle-to-Vehicle (V2V) communication, Vehicle-to-Infrastructure (V2I) communication, etc. that can transmit and receive various items of information between vehicles may be used.

The cloud 200 is configured to receive an emergency request signal from the communication system 110 of a specific vehicle, determines whether the specific vehicle is an emergency vehicle, and then transmits a yielding driving guide signal to vehicles around the specific vehicle.

The cloud 200 may be configured to determine the predetermined signal as an emergency signal and transmit a yielding driving guide signal to vehicles around the specific vehicle when receiving a signal proving that the specific vehicle is an emergency vehicle from an emergency center that has received an emergency report.

The cloud 200 may also be configured to determine the specific vehicle as an emergency vehicle and transmit a yielding driving guide signal to vehicles around the specific vehicle when receiving an image signal (e.g., an image taken by a passenger) that shows an emergency patient in the specific vehicle from the communication system 110 in the specific vehicle.

The yielding driving guide signal which is transmitted to a surrounding vehicle of a specific vehicle by the cloud 200 may include the location information of the specific vehicle, the driving direction of the specific vehicle, the lane change direction of the specific vehicle, a forward safety distance and a safety road width for the specific vehicle, a direction and a movement width for yielding driving of surrounding vehicles, and whether to accelerate or decelerate the surrounding vehicles, etc. The yielding driving guide signal is transmitted to the autonomous driving controllers 100 through the communication systems 110 of the surrounding vehicles.

When receiving an emergency request signal from a specific vehicle, the cloud 200 can determine a forward safety distance and a safety road width for the specific vehicle based on the specifications, current location, driving direction, etc. of the specific vehicle.

Accordingly, the autonomous driving controller 100 is configured to control the surrounding vehicle to move at a speed and in a direction for securing a driving path of the specific vehicle based on the yielding driving guide signal transmitted from the cloud 200.

To the present end, the autonomous driving controller 100 is configured to determine an available road width D of the surrounding vehicle based on a forward safety distance L and a safety road width d for the specific vehicle of the yielding driving guide signal transmitted from the cloud 200, and to determine a yielding driving width B for one surrounding vehicle based on the determined available road width D.

Referring to FIG. 5, the forward safety distance L for a specific vehicle may be determined by multiplying the speed of the specific vehicle by a gain to exclude interference with forward obstacles, and the safety road width d for a specific vehicle may be determined as the sum of the width ‘a’ of the specific vehicle and widths b′ and ‘c’ that are left and right distances from the specific vehicle.

The available road width D for a surrounding vehicle may be determined as a value obtained by subtracting the safety road width d of a specific vehicle from the entire road width A, and the yielding driving width B for one surrounding vehicle may be determined as a value obtained by dividing the available road width D for one surrounding vehicle by the number of lanes.

Accordingly, the autonomous driving controller 100 may be configured to control a surrounding vehicle at a speed and in a direction for securing a driving path of a specific vehicle when the yielding driving width B for one surrounding vehicle is greater than the sum of the width C of the surrounding vehicle and safety widths (spare widths at the left and right sides for preventing interference of a surrounding vehicle).

However, when the yielding driving width B for one surrounding vehicle is smaller than the sum of the width C of the surrounding vehicle and safety widths (spare width at the left and right sides for preventing interference of a surrounding vehicle), a problem may occur with safe driving of the surrounding vehicle, a specific vehicle keeps the driving path while decelerating.

When the communication system 110 of a surrounding vehicle receives a yielding driving guide signal from the cloud 200, information of the yielding driving guide signal is displayed on a display 120 mounted on the surrounding vehicle.

Accordingly, when it is a non-autonomous vehicle without an autonomous driving controller 100, a driver can see information of a yielding driving guide signal displayed on the display 120 and can manually control the subject vehicle in direction at the speed for yielding driving.

A method for inducing vehicles to yield right of way of the present disclosure including the above configuration is sequentially described hereafter.

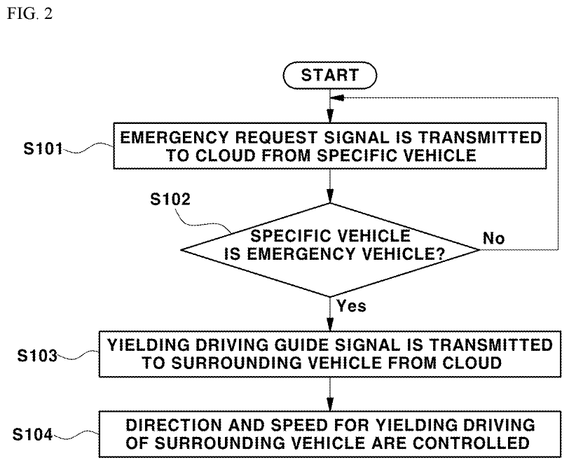

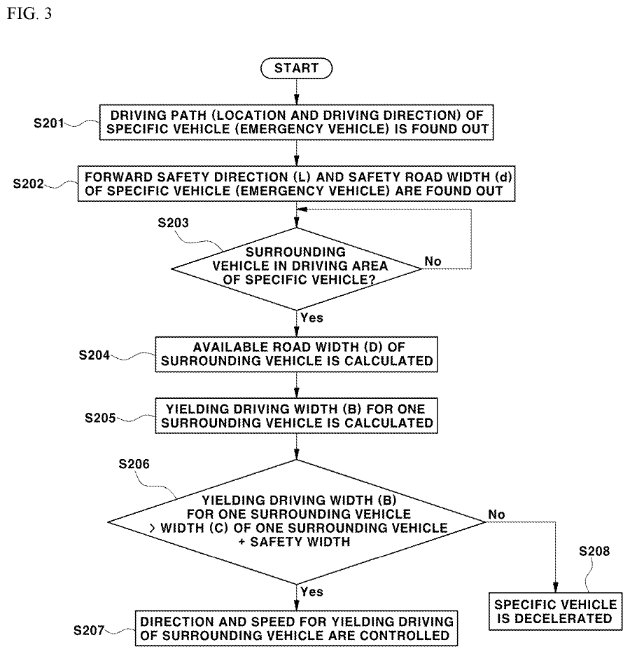

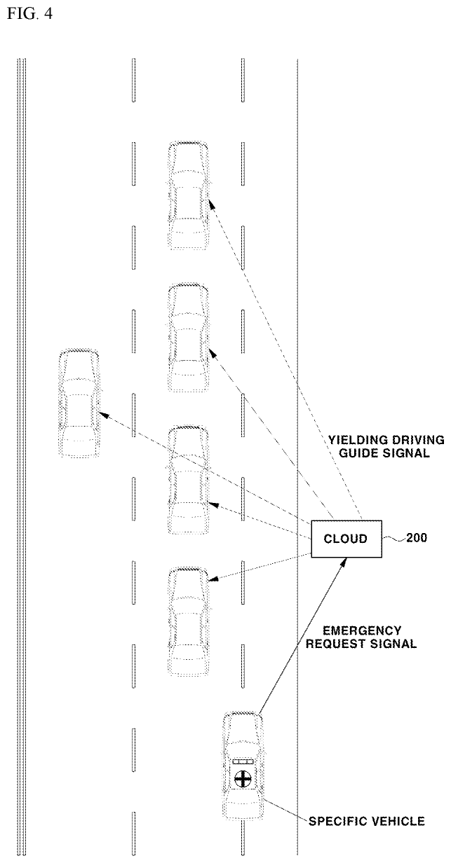

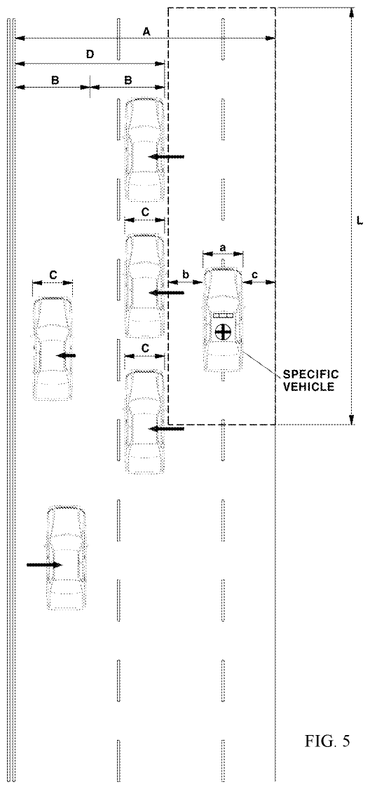

FIG. 2 is a flowchart showing a method for inducing vehicles to yield right of way according to an exemplary embodiment of the present disclosure and FIG. 4 is a schematic diagram showing an example in which a specific vehicle transmits an emergency request to a cloud and then the cloud transmits a yielding driving guide signal to surrounding vehicles.

First, a specific vehicle transmits an emergency request signal to the cloud 200 through the communication system 110 (S101).

For example, a specific vehicle which is being driven on a road can transmit an emergency request signal to the cloud 200 in an emergency.

Next, the cloud 200 determines whether the specific vehicle is an emergency vehicle (S102).

Because the specific vehicle may be an emergency vehicle which may be recognized through a siren or the external shape such as an ambulance and a fire truck or may be a common vehicle with an emergency patient, when the specific vehicle is common vehicle, whether the specific vehicle is an emergency vehicle has to be determined.

To the present end, when determining whether the specific vehicle is an emergency vehicle, the cloud 200 can determine that the specific vehicle is an emergency vehicle when receiving a signal proving that the specific vehicle is an emergency vehicle from an emergency center.

That is, the cloud 200 can determine that the specific vehicle is an emergency vehicle when receiving a signal proving that the specific vehicle is an emergency vehicle from an emergency center that has received an emergency report.

Furthermore, when determining whether the specific vehicle is a true emergency vehicle, the cloud 200 can determine that the specific vehicle is an emergency vehicle when receiving an image signal that shows an emergency patient in the specific vehicle.

That is, when a guardian of an emergency patient in the specific vehicle, or the like transmits an image signal or an image of the emergency patient to the cloud 200 through the communication system 110, the cloud 200 can determine that the specific vehicle is an emergency vehicle.

Next, the cloud transmits a yielding driving guide signal together to surrounding vehicles of the specific vehicle while informing the surrounding vehicles that there is an emergency vehicle in the driving pat (S103).

For example, as shown in FIG. 4, the cloud 200 can transmit a yielding driving guide signal to surrounding vehicles included in the driving area of the specific vehicle determined as an emergency vehicle.

The yielding driving guide signal transmitted to surrounding vehicles of the specific vehicle by the cloud 200 may be received by the autonomous driving controllers 100 through the communication systems 110 of the surrounding vehicles.

In detail, when the cloud 200 transmits a yielding driving guide signal to surrounding vehicles of a specific vehicle, a yielding driving guide signal, which includes the location information of the specific vehicle, the driving direction of the specific vehicle, the lane change direction of the specific vehicle, a forward safety distance and a safety road width for the specific vehicle, and a direction and a movement width for yielding driving of the surrounding vehicles, and whether to accelerate or decelerate the surrounding vehicles, etc., may be received by the autonomous driving controllers 100 through the communication systems 110 of the surrounding vehicles.

Next, the autonomous driving controllers 100 control the surrounding vehicles to move at speeds in directions for securing a driving path of the specific vehicle based on the yielding driving guide signal transmitted from the cloud 200 (S104).

In other words, the autonomous driving controllers 100 control the speeds and directions of the surrounding vehicles for yielding driving based on the yielding driving guide signal transmitted from the cloud 200.

An example of controlling the speed and the direction of a surrounding vehicle is described hereafter.

FIG. 3 is a flowchart showing an example of controlling the direction and the speed of a surrounding vehicle for yielding driving and FIGS. 5 to 10 are schematic diagrams showing various examples in which yielding driving is performed by surrounding vehicles for an emergency vehicle based on the system and method for inducing vehicles to yield right of way according to an exemplary embodiment of the present disclosure.

First, the cloud 200 finds out the driving path (the location and the driving direction) of a specific vehicle determined as an emergency vehicle (S201).

The driving path (the location and the driving direction) of a specific vehicle may be found out from navigation and Global Positioning System (GPS) information, etc. when the cloud 200 receives an emergency request signal from the specific vehicle.

Next, the cloud 200 finds out a forward safety distance and a safety road width for the specific vehicle which is an emergency vehicle (S202).

As shown in FIG. 5, the forward safety distance L and the safety road width d of a specific vehicle may be determined based on the specifications, the current location, the driving direction, etc. of the specific vehicle to set a driving area in which the specific vehicle may be driven without interference with obstacles.

The forward safety distance and the safety road width d of a specific vehicle are a portion of a yielding driving guide signal which is transmitted to the autonomous driving controllers 100 through communication systems 110 of surrounding vehicles from the cloud 200. Accordingly, a yielding driving guide signal, which includes the location information of a specific vehicle, the driving direction of the specific vehicle, the lane change direction of the specific vehicle, a direction and a movement width for yielding driving of surrounding vehicles, and whether to accelerate or decelerate the surrounding vehicles, etc., may be transmitted to the autonomous driving controllers 100 through communication systems 110.

Next, the cloud 200 checks whether there is a surrounding vehicle in the driving area including the forward safety distance and the safety road width of the specific vehicle which is an emergency vehicle (S203).

As the result of checking, if there is no surrounding vehicle in the driving area of the specific vehicle, the specific vehicle keep going, and if there is a surrounding vehicle in the driving area of the specific vehicle, the surrounding vehicle receives the yielding driving guide signal from the cloud 200 and can perform yielding driving.

To the present end, the autonomous driving controller 100 of the surrounding vehicle determines an available road width D for the surrounding vehicle based on the forward safety distance L and the safety road width d for the specific vehicle (S204).

The available road width D for the surrounding vehicle, as shown in FIG. 5, may be determined as a value obtained by subtracting the safety road width d for the specific vehicle from the entire road width A.

Next, the autonomous driving controller 100 of the surrounding vehicle determines a yielding driving width B for one surrounding vehicle based on the available road width D for the surrounding vehicle (S205).

The yielding driving width B for one surrounding vehicle, as shown in FIG. 5, may be determined as a value obtained by dividing the available road width D for the surrounding vehicle by the number or lanes.

Next, the autonomous driving controller 100 compares the yielding driving width B for one surrounding vehicle with the sum of the width C of one surrounding vehicle and a safety width (spare widths at the left and right sides for preventing interference of a surrounding vehicle) (S206).

As the result of comparison, when the yielding driving width B for one surrounding vehicle is greater than the sum of the width C of one surrounding vehicle and the safety width, the direction and speed of the surrounding vehicle is controlled by the autonomous driving controller 100 so that a driving path of the specific vehicle is secured (S207).

For example, as shown in FIG. 5, when the specific vehicle is driven straight, the direction for yielding driving of surrounding vehicles may be determined as the left by the autonomous driving controllers 100 to secure a driving path of the specific vehicle.

Furthermore, as shown in FIG. 6, a surrounding vehicle out of the driving area including the forward safety distance and the safety road width for the specific vehicle may be controlled to return to the previous driving position by the autonomous driving controller 100.

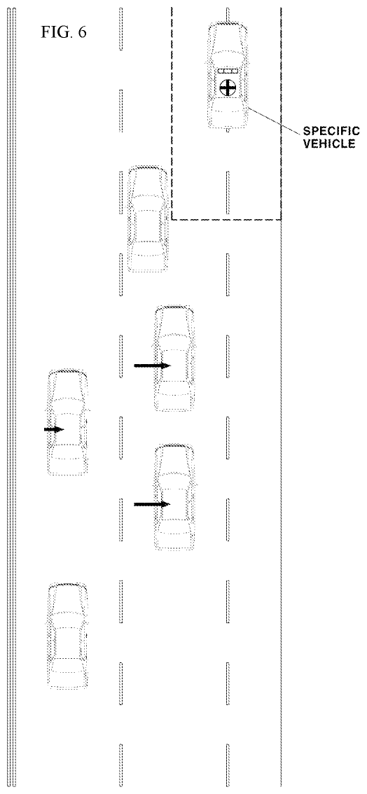

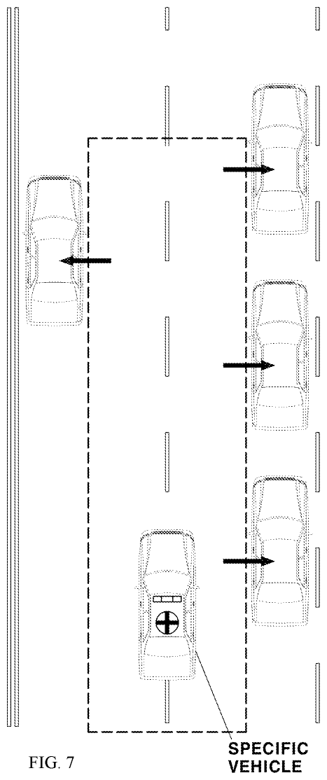

Furthermore, as shown in FIG. 7, when the specific vehicle is driven straight, the direction for yielding driving of surrounding vehicles may be determined as the left and the right by the autonomous driving controllers 100 to secure a driving path of the specific vehicle.

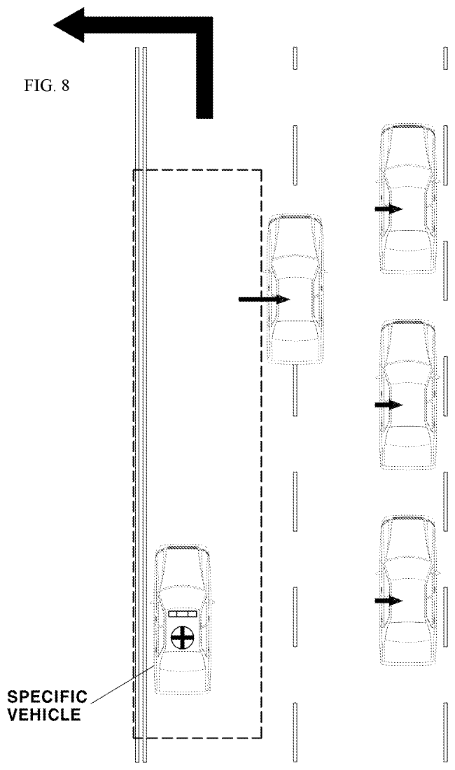

Furthermore, as shown in FIG. 8, when the specific vehicle intends to turn left, the direction for yielding driving of surrounding vehicles may be determined as the right by the autonomous driving controllers 100 to secure a driving path of the specific vehicle.

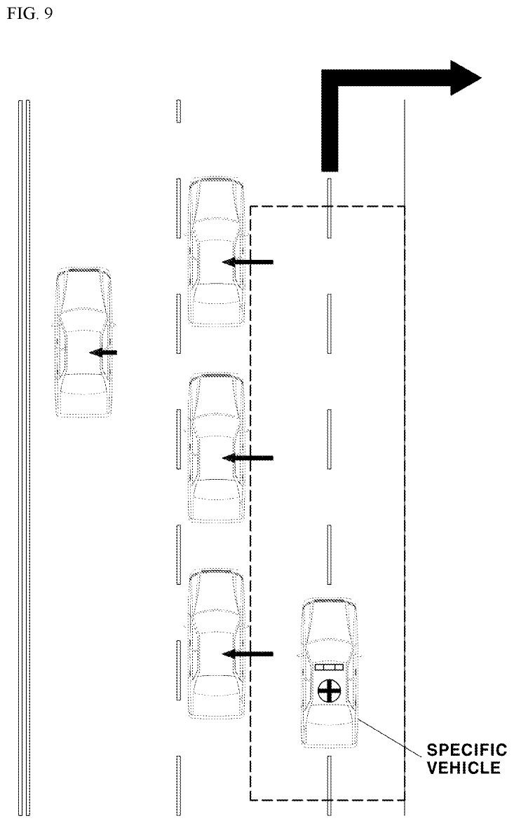

Furthermore, as shown in FIG. 9, when the specific vehicle intends to turn right, the direction for yielding driving of surrounding vehicles may be determined as the left by the autonomous driving controllers 100 to secure a driving path of the specific vehicle.

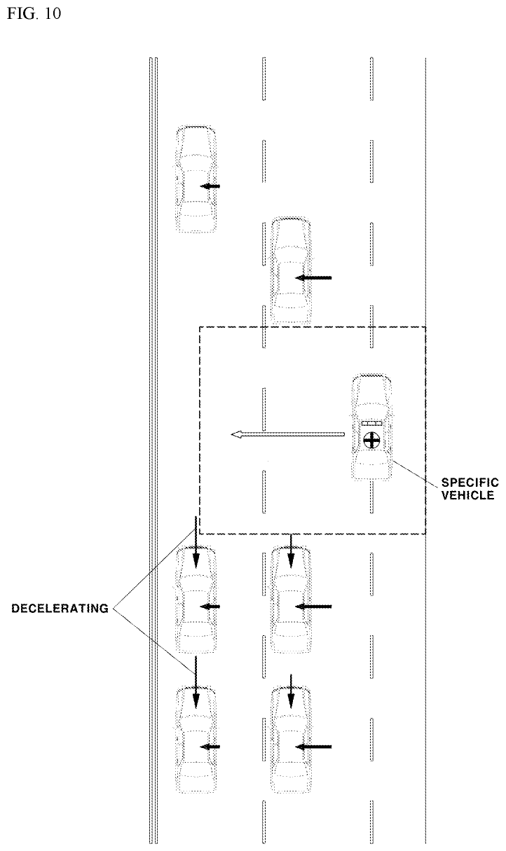

Furthermore, as shown in FIG. 10, when the specific vehicle changes the lane, the vehicles, which are positioned behind the specific vehicle, of surrounding vehicles may be controlled to decelerate by the autonomous driving controllers 100 to secure a driving path of the specific vehicle.

However, as the result of comparison in step S206, when the yielding driving width B for one surrounding vehicle is smaller than the sum of the width C of the surrounding vehicle and safety widths (spare width at the left and right sides for preventing interference of a surrounding vehicle), because a problem may occur with safe driving of the surrounding vehicle, the specific vehicle stands by while decelerating in the driving path until yielding driving may be performed by repetition of steps S201 to S206 (S208).

When the communication system 110 of a surrounding vehicle receives a yielding driving guide signal from the cloud 200, information of the yielding driving guide signal is displayed on a display 120 mounted on the surrounding vehicle.

Accordingly, when it is a non-autonomous vehicle without an autonomous driving controller 100, a driver can see information of a yielding driving guide signal displayed on the display 120 and can manually control the subject vehicle in direction at the speed for yielding driving.

As described above, when a specific vehicle transmits a request signal showing that the specific vehicle is an emergency vehicle to a cloud, the cloud determines whether the specific vehicle is a true emergency vehicle, and then informs surrounding vehicles that there is an emergency vehicle in the driving path. Accordingly, yielding driving may be easily performed even for specific vehicles with an emergency patient other than emergency vehicles such as an ambulance and a fire truck, and accordingly, it is possible to rapidly carry an emergency patient and take following measures.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for inducing vehicles to yield right of way, the system comprising:
a communication device mounted in each of a fleet of the vehicles;
a cloud configured to receive an emergency state signal from the communication device of a vehicle of the fleet of vehicles, and determine an emergency state, and then to transmit a guide signal requesting surrounding vehicles to yield the right of way to the vehicle in the emergency state; and
an autonomous driving controller configured, based on the guide signal, to control the surrounding vehicles at a speed and in a direction so that a driving path of the vehicle in the emergency state is secured.

2. The system of claim 1, wherein the cloud is configured to conclude that the vehicle is in the emergency state when receiving a signal proving the emergency state from an emergency center.

3. The system of claim 1, wherein the cloud is configured to conclude that the vehicle is in the emergency state when receiving an image showing that there is an emergency patient aboard the vehicle.

4. The system of claim 1, wherein the cloud is configured to transmit a yielding driving guide signal, which includes location information of the vehicle, a driving information of the vehicle, a lane change direction of the vehicle, a forward safety direction and a safety road width of the vehicle, a direction and a movement width for yielding driving of the surrounding vehicles, and whether to accelerate or decelerate the surrounding vehicles, to an autonomous driving controller of the surrounding vehicles.

5. The system of claim 4, wherein the autonomous driving controller is configured to determine an available road width for the surrounding vehicles based on the forward safety direction and the safety road width of the vehicle, and to determine a yielding driving width for one surrounding vehicle based on the determined available road width for the one surrounding vehicle.

6. The system of claim 5, wherein the autonomous driving controller is configured to control the surrounding vehicles at a speed and in a direction for securing a driving path of a predetermined direction when the yielding driving width for the one surrounding vehicle is greater than a sum of a width of the one surrounding vehicle and a safety width.

7. The system of claim 6, wherein the autonomous driving controller is configured to control the vehicle to be decelerated when the yielding driving width for the one surrounding vehicle is equal to or smaller than the sum of the width of the one surrounding vehicle and the safety width.

8. The system of claim 4, wherein a display mounted in the surrounding vehicles and configured to display information of the yielding driving guide signal.

9. A method for inducing vehicles to yield right of way, the method comprising:
transmitting, by a communication system of a vehicle, an emergency request signal to a cloud;
determining, by the cloud, whether the vehicle is an emergency vehicle;
transmitting, by the cloud, a yielding driving guide signal to surrounding vehicles of the vehicle when the vehicle is an emergency vehicle; and
controlling, by an autonomous driving controller, the surrounding vehicles at a speed and in a direction for securing a driving path of the vehicle based on the yielding driving guide signal.

10. The method of claim 9, wherein, in the determining of whether the vehicle is the emergency vehicle, the cloud is configured to conclude that the vehicle is the emergency vehicle when receiving a signal, which proves that the vehicle is the emergency vehicle, from an emergency center.

11. The method of claim 9, wherein, in the determining of whether the vehicle is the emergency vehicle, the cloud is configured to conclude that the vehicle is the emergency vehicle when receiving an image signal showing that there is an emergency patient in the vehicle.

12. The method of claim 9, wherein when transmitting the yielding driving guide signal to the surrounding vehicles, the cloud is configured to transmit the yielding driving guide signal, which includes location information of the vehicle, a driving information of the vehicle, a lane change direction of the vehicle, a forward safety direction and a safety road width of the vehicle, a direction and a movement width for yielding driving of the surrounding vehicles, and whether to accelerate or decelerate the surrounding vehicles, to an autonomous driving controller of the surrounding vehicles.

13. The method of claim 12, wherein the autonomous driving controller is further configured to perform:
determining an available road width for the surrounding vehicles based on the forward safety direction and the safety road width of the vehicle; and
determining a yielding driving width for the surrounding vehicles based on the determined available road width for the surrounding vehicles.

14. The method of claim 13, wherein the autonomous driving controller is configured to control the surrounding vehicles at a speed and in a direction for securing a driving path of a predetermined direction when the yielding driving width for one surrounding vehicle is greater than a sum of a width of the one surrounding vehicle and a safety width.

15. The method of claim 14, wherein the autonomous driving controller is configured to control the vehicle to be decelerated when the yielding driving width for the one surrounding vehicle is equal to or smaller than the sum of the width of the one surrounding vehicle and the safety width.

16. The method of claim 9, further including displaying information of the yielding driving guide signal on a display mounted in the surrounding vehicles.
